(19) United States
(12) Patent Application Publication
(10) Pub. No.: US 2024/0391612 A1
(43) Pub. Date: Nov. 28, 2024

(54) FORT - Fungus-Operated Radiation Transforming shield for rigid structures

(71) Applicant: Eszter Gulacsi, Caselle Torinese (IT)

(72) Inventor: Eszter Gulacsi, Caselle Torinese (IT)

(21) Appl. No.: 18/202,319

(22) Filed: May 26, 2023

(51) Int. Cl. B64G 1/54; G21F 1/10

(52) U.S. Cl. CPC B64G 1/54; G21F 1/10

(57) ABSTRACT

The increasing desire to establish an extra-terrestrial human base, and the aim to live and work in deep space either in Lunar orbit or on the way to Mars requires space radiation shielding in order to protect humans and sensitive equipment against solar radiation and Galactic Cosmic Rays. Mycelium (fungi) is widespread on Earth and has existed for almost a billion years, even when the radiation level on our planet was much higher than nowadays and fungi thrived under those conditions. Moreover, over that, almost a billion years fungi developed the most sophisticated and reliable defence systems against viruses, bacteria, radiation, extreme temperature and even physical damage. Research and experiments on how fungi can withstand radiation have been carried out for a decade. FORT shield intends to utilise those research results and apply them to create a shielding for rigid structures that can ensure safe human exploration outside of the protection of Earth's magnetic field. FORT shield could also be used on satellites to be protected by radiation and to generate additional power for end-of-life manoeuvres. Keywords: fungi, melanin, space radiation, deep space, spacecraft, satellites, architectural radiation shielding, space exploration, human spaceflight

FORT shield is an architectural space radiation shielding to be used for rigid structures, like the pressurized modules of the International Space Station, the pressurized modules of the Axiom commercial space station currently under manufacturing and satellites. The aim of this shielding is to protect humans and sensitive equipment on board against solar radiation and Galactic Cosmic Rays. The shielding needs to be installed before launch but it can be repaired in space by 3D printing the panels on board and replacing any external panels damaged by micrometeorites, space debris or EVAs.

The FORT shield is made up of a carbon fibre supporting structure, biofilm for growing fungi, the fungi itself and a biodegradable, transparent film to cover the fungi.

Biofilms, like the Kombucha Membrane are cheap to create as it is a by-product of fermenting Kombucha drinks. It also protects the cells within and provides sufficient nutrition to the fungi to create a thick layer of mycelium during the assembly and integration period that can take a long time (12-24 months in some cases).

The substructure that holds the trays with the biofilm and creates a ‘crawling space’ between the shielding and the pressurized module, contains carbon fibre or metal alloy (lightweight but strong) cantilevers fixed to the external structure of the spacecraft, and carbon fibre trays arranged with an overlap to prevent any gaps in the shielding. As the cantilevers are installed in place of the grab-rails for EVA, the handrails need to be fixed above the shielding, to the cantilevers in order to support extra-vehicular activities (EVAs) without creating a gap in the radiation protection.

The proposed fungi to use is Aspergillus Niger as they are highly resistant to stressors (radiation, extreme temperatures, vacuum) and can be melanised quickly, moreover, it is way less harmful to humans than the other candidate, Cryptococcus neoformans.

The biofilm would be infused with nutrition to provide food for the fungi to grow a thick layer, but dependent on the length of the integration and preparation stage, this SCOBY (Symbiotic Culture Of Bacteria and Yeast) biofilm can be replaced by malt extract agar. The spread of the fungi could take a couple of days, dependent on the size of the area which needs to be covered by fungi and the inoculum size (how much fungi are visible initially). A 10 cm diameter petri dish is fully covered in 15 days from 2-3 drops of liquid culture on the ME agar plate.

The fungi layer would produce indestructible melanin once it is introduced to stressors like radiation, extreme temperature or vacuum. Anything which means limited nutrient conditions for the fungus. 1L liquid culture of A. niger becomes black in 72 hours and colonies on an agar plate turn black within 5 days.

A biodegradable, transparent film is proposed to cover the fungi colony that protects the assembly and testing crew during the integration of the payload from any spores getting into the air, and later, once the spacecraft is in space, it protects the fungi and biofilm to crumble away. The fungi will not die in space but it gets dormant therefore it will not continue to grow or produce more melanin.

As the melanin absorbs space radiation and turns it into heat that is radiated away from the surface of the melanin in the form of thermal radiation, the surface of the melanin is supposed to be much warmer than the vacuum between the FORT shield and the pressurized module. Using thermoelectric couplers the temperature difference can be used to generate electricity.

FORT shield can be beneficial for satellites where sensors need protection from radiation, the black pigments would cover constellations from human eyes on Earth and the additional electricity generated by FORT shield could be stored in batteries or used as necessary.

The carbon fibre trays with fungi in them can be manufactured on the spacecraft, space station or on an extraterrestrial base by 3D printing, and replaced during a simple extra-vehicular activity (EVA). In space, where the FORT shield panels are made to replace damaged ones, using spores the fungus will spread evenly on the 3D printed carbon fibre tray and cover them quickly. These panels can be kept on racks and used when a (terrestrial pre-fabricated) panel needs to be replaced or patched up.

Melanin can be manufactured on its own but it does not provide the same protection as the melanised fungi.

Spores can be launched as payload, a vial full of spores (millions of spores) weights less than a drop of water and 1-2 spores are enough to inoculate a panel.

### REFERENCE TO DRAWINGS

FIGS. 1.—3D view sketch of the modular FORT Shield showing the pressurized module (based on the information provided by JAXA on the KIBO module), the cantilevers holding the trays away from the pressurized module and installed into the existing trench. The cantilevers provide a crawl space for astronauts to carry out repairs on the spacecraft if necessary and it also ensures that FORT Shield is separated from the spacecraft. The trays are laid in a pattern to allow the biofilm with fungal matter and biodegradable transparent film to overlap with the neighbouring modules. Handrails are fixed in line with the cantilevers for Extravehicular Activity.

FIG. 2.—Cross section sketch of the modular FORT Shield showing the pressurized module (based on the information provided by JAXA on the KIBO module), the cantilevers holding the trays away from the pressurized module and installed into the existing trench. The cantilevers provide a crawl space for astronauts to carry out repairs on the spacecraft if necessary and it also ensures that FORT Shield is separated from the spacecraft. The trays are laid in a pattern to allow the biofilm with fungal matter and biodegradable transparent film to overlap with the neighbouring modules. Handrails are fixed in line with the cantilevers for Extravehicular Activity.

FIG. 3.—Detail sketch of the modular FORT Shield showing the cantilever, the tray with the layering of the fungal biofilm and biodegradable transparent film.

FIG. 4.—BIM drawings (Ground Floor Plan, Generic Perspective, Building Section and External view) of the modular FORT Shield based on the information JAXA has provided of the KIBO module.

FIG. 5.—Schematized flow chart of the procedure of creating a prototype of FORT Shield. From left to right, using existing Agar plate with Aspergillus niger culture to inoculate the nutritional-filled biofilm with a small piece of mycelium. After a couple of weeks, the biofilm is fully colonised and ready to be irradiated at a radiation lab.

FIG. 6.—Schematized assembly drawing of the modular FORT Shield. Showing that the cantilever is fixed into the existing trench of the pressurized module, the tray is fixed to the cantilever, the biofilm sits in the tray and on the grab rail for EVA on top.

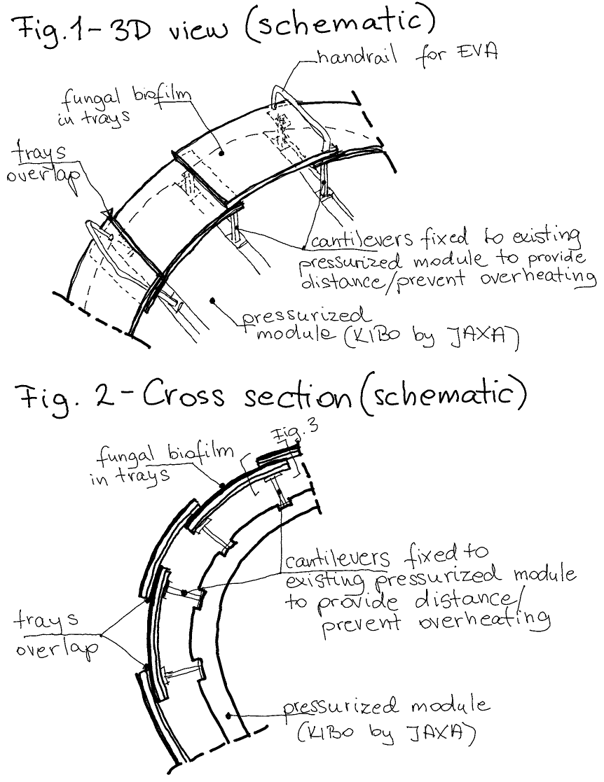

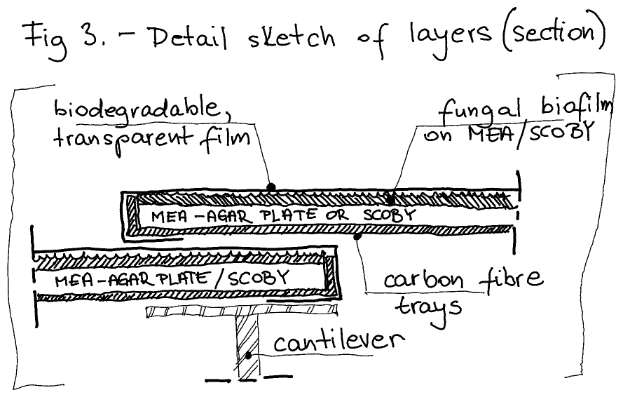

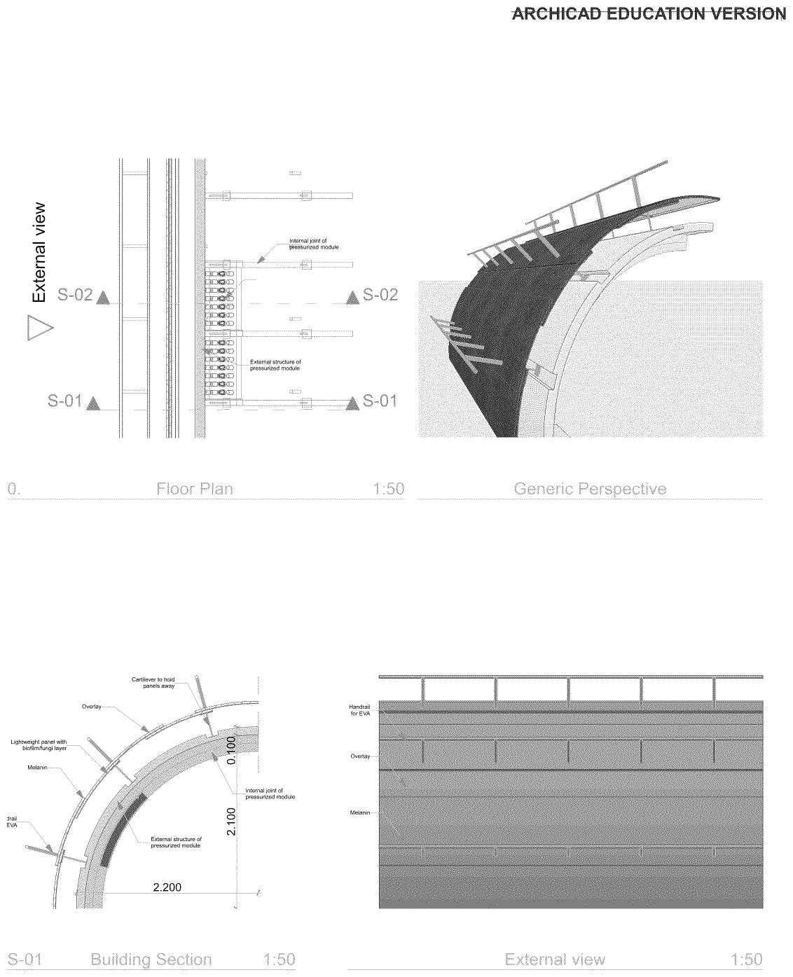

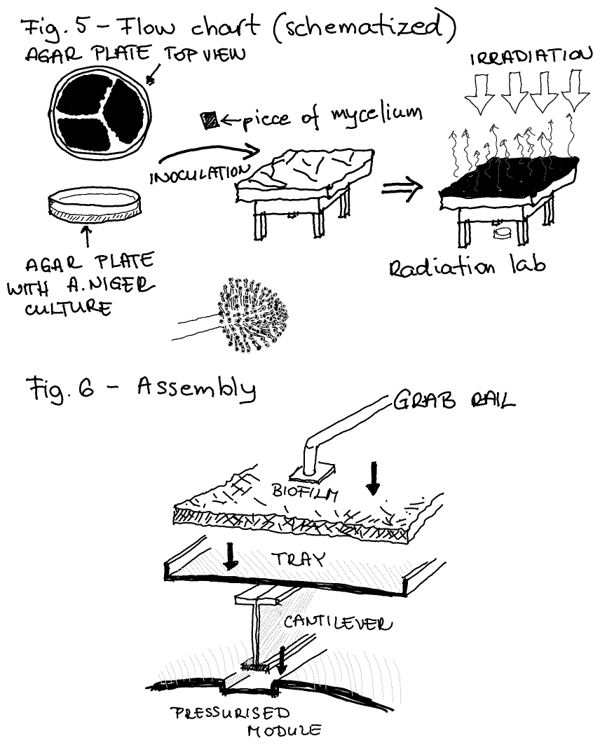

1. The application of research science in order to create architectural radiation shielding for rigid structures in order to protect humans and sensitive equipment from radiation.
